(19) United States
(12) Patent Application Publication
(10) Pub. No.: US 2014/0291984 A1
(43) Pub. Date: Oct. 2, 2014

(54) CONNECTOR UNIT

(71) Applicant: Fränkische Industrial Pipes GmbH & Co. KG, Königsberg (DE)

(72) Inventor: Benjamin Dorsch, Hassfurt (DE)

(21) Appl. No.: 14/353,945

(22) PCT Filed: Oct. 26, 2012
(86) PCT No.: PCT/EP2012/071274

§ 371 Date: Apr. 24, 2014

(30) Foreign Application Priority Data
Oct. 28, 2011 (DE) 10 2011 085 398.7

(51) Int. Cl. F16L 25/00

(52) U.S. Cl. CPC F16L 25/0045
USPC 285/315

(57) ABSTRACT

A connector unit includes a base body with a mount for a pipe, at least one holding element which enters into holding engagement with a circumferential recess of the pipe, and a control sleeve displaceable relative to the base body, wherein the control sleeve is displaceable between a first and a second axial positions, wherein the holding element in the first axial position is in holding engagement with the pipe, which can be released in the second axial position. The control sleeve in the first axial position can be displaced in a circumferential direction between a first and a second rotational positions, wherein the control sleeve in its first rotational position can be displaced into the second axial position, whereas in the second rotational position it is held by the base body in an interlocking manner in the first axial position.

The invention relates to a connector unit, comprising a base body with a mount delimited by an insertion opening for a pipe that does not form part of the connector unit, for example a corrugated pipe, or for a hose that does not form park of the connector unit, at least one holding element which is configured and designed to enter into holding engagement with a circumferential recess of the pipe or hose and a control sleeve guided on the base body displaceably relative thereto, wherein the control sleeve can be displaced in the direction of a longitudinal axis of the base body relative thereto between a first axial position and a second axial position, wherein the at least one holding element in the first axial position of the control sleeve is in holding engagement with the circumferential recess of the pipe or the hose, whereas said holding engagement can be released in the second axial position of the control sleeve.

A generic connector unit is known for example from EP 0 465 896 A1, in the known connector unit the control sleeve comprises two ring elements one of which is inserted into the base body and the other of which is arranged in both axial positions as a manipulation end outside the base body, and the at least one holding element is arranged at the free end of a web which protrudes from one ring element in the direction of the other ring element. Furthermore, in the known connector unit the control sleeve in its second axial position is pushed essentially completely into the base body, whilst in the first axial position it is pulled out of the base body by a defined amount. This means that when essentially fully inserted into the base body the engagement of the at least one holding element with the pipe or the hose can be released. This is a disadvantage, as in practice there is more of a risk that the control sleeve could be pushed unintentionally into the base body than pulled out thereof. Therefore, the security of the known connector unit with regard to the unintentional detachment of the pipe or hose from the base body leaves much to be desired.

Therefore, the problem to be solved by the invention is to develop a connector unit of the generic type such that the unintentional detachment of the pipe or hose from the base body can be avoided in a reliable manner or at least made much more difficult.

Said problem is solved by a connector unit of the generic type, in which the control sleeve in the first axial position can be displaced in circumferential direction about the longitudinal axis of the base body between a first rotational position and a second rotational position, wherein the control sleeve in its first rotational position can be displaced into the second axial position, whereas in the second rotational position it is held by the base body in an interlocking manner in the first axial position, i.e. in the axial position in which the at least one holding element is in holding engagement with the circumferential recess of the pipe or hose. The interlocking hold of the control sleeve in the first axial position thus secures the engagement of the at least one holding element with the circumferential recess of the pipe or hose.

An additional degree of security can be provided in that the control sleeve in the second rotational position is locked in place on the base body.

The aforementioned first and second axial positions and first and second rotational positions can be achieved structurally in a simple manner in that the control sleeve comprises at least one control piece, which is mounted in a substantially L-shaped displacement path of the base body, for example a window in a circumferential wall of the base body, wherein the L-shape comprises one branch running substantially in the direction of the longitudinal axis and one branch running substantially in circumferential direction.

The substantially L-shaped displacement path can be formed independently of openings in a circumferential wall of the base body in said circumferential wall. Alternatively it is also possible to allow it to merge into such openings or to use parts of such openings as one of the L-branches. For example, the branch of the L-shape running in the direction of the longitudinal axis can open into a window of the base body in that the at least one holding element is mounted preferably on the side of said window averted from the insertion opening for the pipe or the hose. In this case the substantially L-shaped displacement path adjoins the holding element mounting window axially. This enables the arrangement of a large number of holding elements over the circumference of the base body. Alternatively the branch of the L-shape running in the direction of the longitudinal axis can be formed by a window of the base body, in which the at least one holding element is also mounted. In this case the displacement path adjoins the holding element mounting window in circumferential direction. This enables the formation of particularly short connector units in axial direction.

In order to assemble the connector unit using as few parts as possible it is preferable if no additional component is needed to form the at least one holding element. According to the invention the least one holding element can be integral with the base body. For example, the at least one holding element can be formed by a tongue which protrudes from an outer delimiting wall of the base body in a direction pointing radially inwards and away from the insertion opening. In this way when inserting the pipe or hose into the base body a barbed hook effect can be achieved. In order to reverse this barbed hook effect to release the pipe or hose again the tongue can be deflected in the second axial position by the control sleeve in the direction of the outer delimiting wall. Alternatively, however, it is also possible for the at least one holding element to be integral with the control sleeve, as is known per se from EP 0 465 896 A1. Although such an embodiment is not illustrated and described in detail in the following, it is also possible in principle to achieve both alternatives with the same connector unit. For this purpose it is simply necessary for the pipe or the hose to comprise at least two corresponding circumferential recesses, which is easily the case when using a corrugated pipe.

In a further development of the invention it is possible for the mount of the base body to have an annular shoulder at its end farthest from the insertion opening for the pipe or hose. Said annular shoulder can perform different functions For example it can delimit the insertion movement of the control sleeve into the base body. In addition or alternatively, it can also be used for supporting an annular seal, preferably in the form of an annular sleeve, the external circumference of which decreases towards the annular shoulder for example.

However, as an alternative to providing a separate sealing element on the radial inner edge of the annular shoulder, a cylindrical flange pointing towards to the insertion opening can be provided, which flange together with the outer delimiting wall of the base body and the annular shoulder forms a sealing recess for the pipe or the hose that tapers preferably towards the annular shoulder. The sealing effect is created in this case by the interaction of the pipe or hose with the seal recess, in particular the bearing of the pipe or hose on the seal recess. The cylindrical flange can preferably be integral with the base body.

As already indicated above, the control sleeve can be guided on the base body in a simple manner if it is also arranged in the mount. IL is also advantageous if one of the axial ends of the control sleeve projects out of the mount. Said end can then, as already mentioned above, be used as an actuating end for the control sleeve. For example for this purpose it can comprise a radially outwardly protruding annular flange, which projects radially over the base body and is preferably provided with finger grooves which make it easier to grip in particular.

The invention is explained in the following by way of three embodiments with reference to the attached drawings in which:

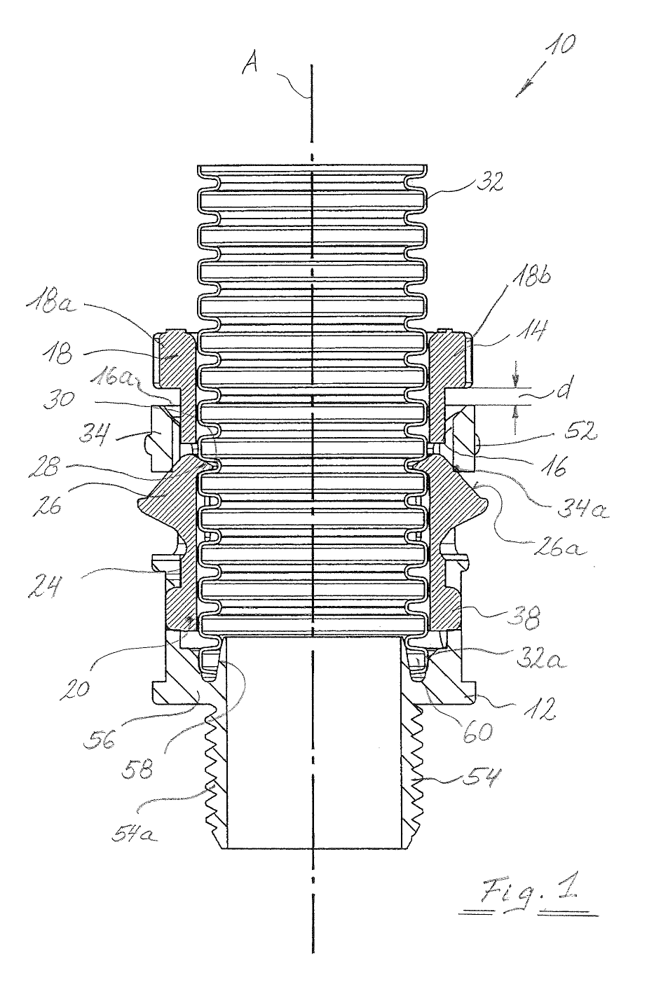

FIG. 1 shows a longitudinal cross section of a first embodiment of a connector unit according to the invention;

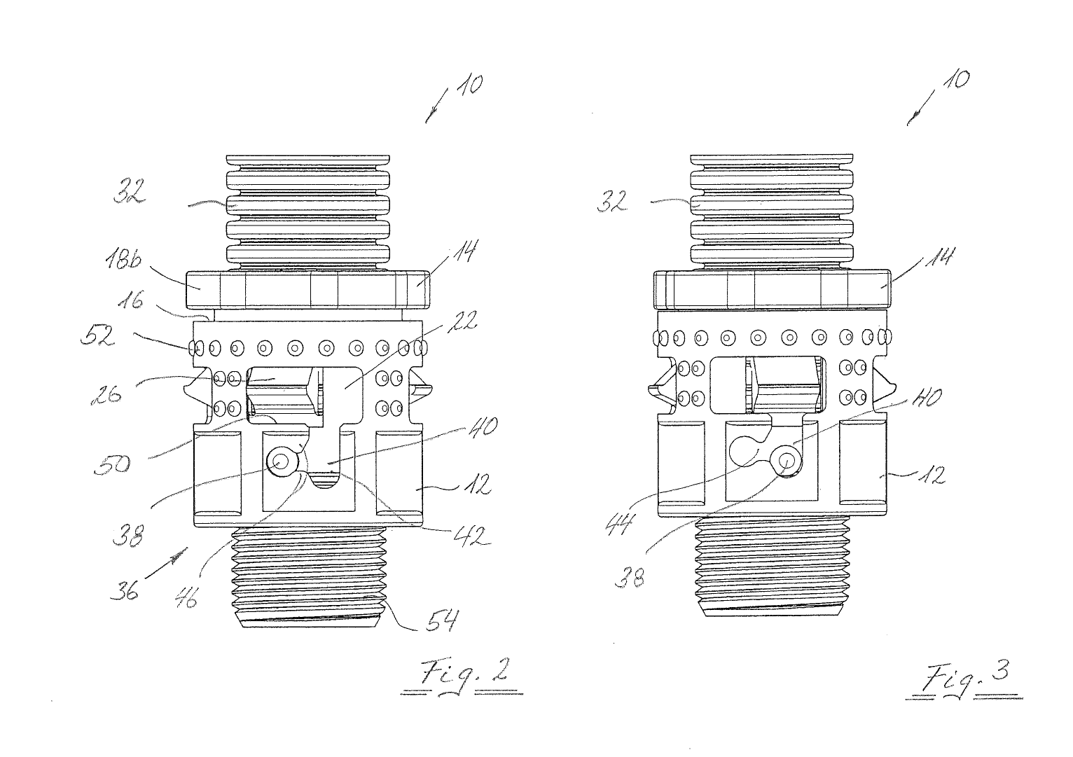

FIG. 2 shows a plan view of the connector unit according to FIG. 1, in which the control sleeve is positioned relative to the base body in the first axial position and the second rotational position;

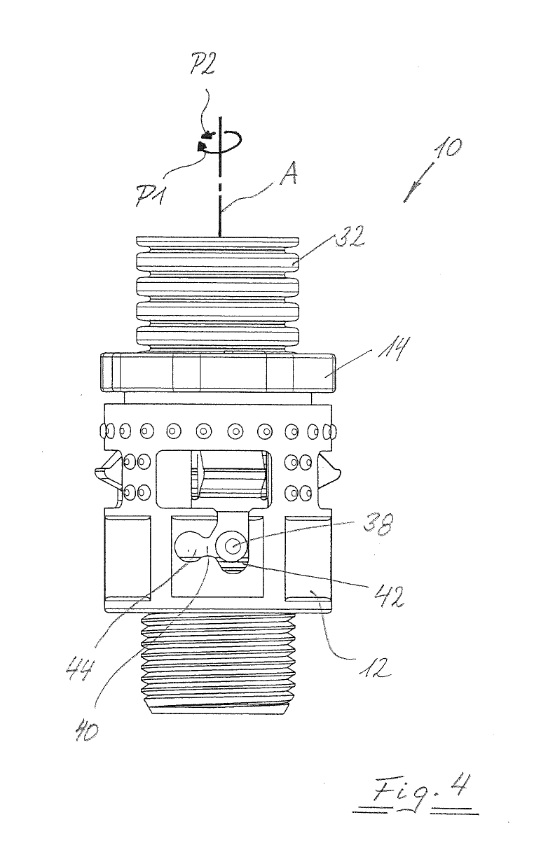

FIG. 3 shows a view similar to FIG. 2 but in which the control sleeve is located in the second axial position and the first rotational position;

FIG. 4 shows a view similar to FIGS. 2 and 3 but in which the control sleeve is located in the first axial position and the first rotational position;

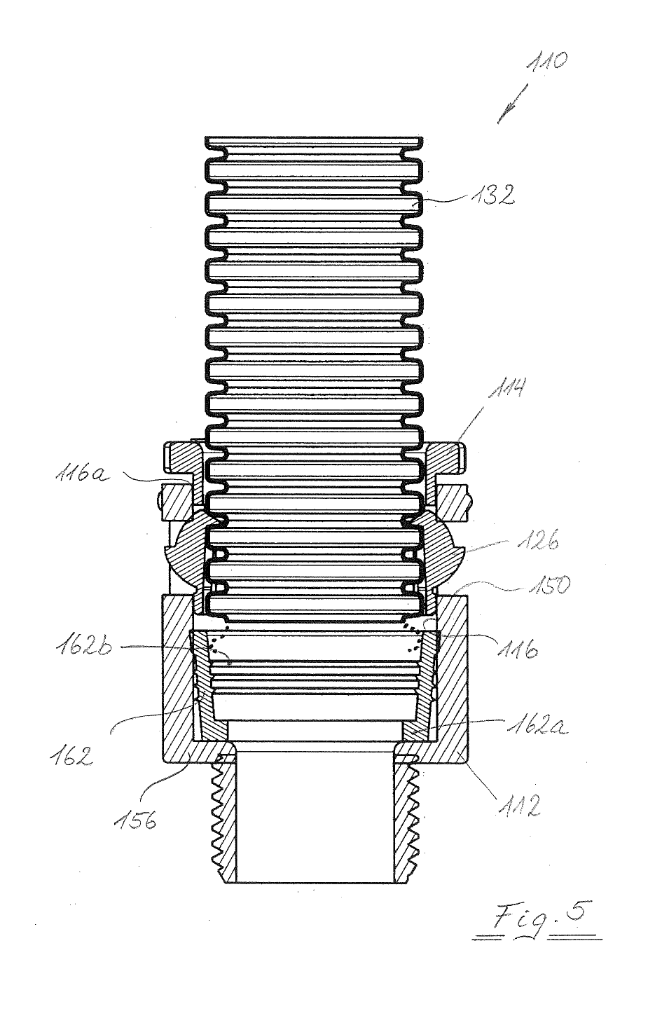

FIGS. 5 to 7 show views similar to FIGS. 1 to 3 of a second embodiment of the invention; and

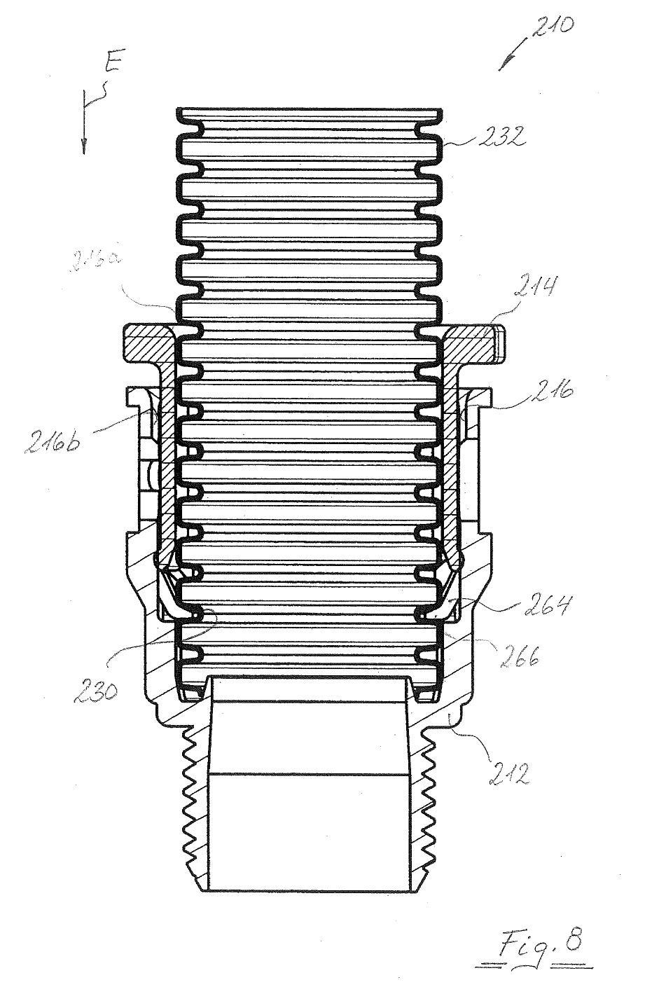

FIGS. 8 to 10 show views similar to FIGS. 1 to 3 of a third embodiment of the invention.

In FIG. 1 a connector unit according to the invention is denoted in general by 10. It comprises a base body 12 and a control sleeve 14 which is inserted into a mount 16 of the base body.

The control sleeve 14 comprises two annular sections 18 and 20 which are joined together to form a single piece by means of axial webs 22 (see FIG. 2). Tongues 24 protrude between the axial webs 22 in axial direction from the lower annular section 20 in FIG. 1, i.e. the annular section which is farthest from the insertion opening 16a of the mount 16 and is arranged in the mount 16 of the base body 12, and at the free end of the tongues a holding element 26 is arranged respectively. The holding elements 26 can be connected to the respectively assigned tongue 24 to be pivotable radially inwardly and outwardly about an axis running substantially parallel to the respective local tangential direction. The holding element 26 is configured to have a radially inwardly protruding holding projection 28 which is intended to enter into engagement with a circumferential recess 30 of a pipe 32 inserted into the mount 16 of the base body 12.

In the embodiment shown the pipe 32 is in the form of a corrugated pipe with an alternating sequence of wave crests and troughs, wherein each wave trough may form a circumferential recess within the meaning of the present invention.

The control sleeve 14 can be adjusted relative to the base body 12 between a first axial position (see FIGS. 1, 2 and 4) and a second axial position (see FIG. 3).

In the first axial position the control sleeve 14 is pulled out of the base body 12 by the distance d. During the removal movement necessary for this, the holding elements 26 with an outer oblique surface 26a push against the inner edge 34a of an annular section 34 of the base body 12 forming the insertion opening 16a. From the interaction of the oblique surface 26a of the holding element 26 with the edge 34a of the annular section 34 the holding element 26 is forced radially inwards during the further removal of the control sleeve 14 from the base body 12 until it engages in the circumferential recess 30 of the pipe 32 and thus holds said pipe in the connector unit 10.

In the second axial position according to FIG. 3 the outer annular section 18 of the control sleeve 14 rests against the annular section 34 of the base body 12, i.e. the control sleeve 14 is inserted fully into the base body 12 or its mount 16. In this state the connection between the holding elements 26 and the annular section 34 of the base body 12 is released so that the locking projections 28 of the holding elements 26 can move back out of the circumferential recess 30 of the pipe 32 and the pipe 32 can thus be released from the connector unit 10.

To prevent the control sleeve 14 being pushed involuntarily into the mount 16 of the base body 12, which means that there is a risk that the pipe 32 may become detached from the connector unit 10 unintentionally, the connector unit 10 is provided with an additional securing device 36. Said additional securing device 36 is formed by a projection 38 arranged on the control sleeve 14, preferably integral with said control sleeve, and is mounted in a substantially L-shaped window 40 of the base body. The substantially L-shaped window 40 has an L-branch 42 extending substantially in axial direction and an L-branch 44 extending substantially in circumferential direction.

If the shoulder 38 is located at the free end of the axial L-branch 42 (see FIG. 3), the control sleeve is positioned relative to the base body in its second axial position in which the pipe 32 can be released from the connector unit 10 or a pipe 32 can be inserted into the connector unit 10.

If the pipe 32 is to be secured in the connector unit 10 the control sleeve 14 is pulled out of the base body 12 by the predetermined amount d (see FIG. 1). At the same time the shoulder 38 in the substantially L-shaped window 40 moves to the connecting point of the two L-branches 42 and 44 (see FIG. 4). The connector unit 10 is then in its locked but not yet secured state relative to the pipe 32.

To achieve the locked and secured state of the connector unit 10 the control sleeve 14 is rotated relative to the base body 12 in a circumferential direction about the axis A, in the direction of arrow P1 in FIG. 4, until the shoulder 38 is positioned at the free end of the circumferential branch 44 of the substantially L-shaped window 40 (see FIG. 2). In this position the projection 38 can no longer move in axial direction, as it is held in an interlocking manner in the second axial position by the delimiting edge of the circumferential branch 44. Said interlocking fit secures the locked state of the connector unit 10 and pipe 32. For additional security the position of the shoulder 38 is secured at the free end of the circumferential branch 44 of the substantially L-shaped window 40 by catch projections 46, which resist a rotation of the control sleeve 14 relative to the base body 12 in the direction of the arrow P2 according to FIG. 4.

It should also be added that the holding elements 26 are mounted in windows 50 of the base body 12 so that their pivot position relative to the pipe 32 can be seen from the outside and thus can be easily verified.

In the embodiment according to FIGS. 1 to 4 the securing device 36 is arranged axially adjacent to the holding element mount window 50. In particular, the shoulder 38 in axial direction is substantially aligned with the holding element 26. Furthermore, the substantially L-shaped window 40 merges into the holding element mounting window 50 in an extension of the axial branch 42 via the connecting point of the two branches 42 and 44.

It should also be mentioned that the upper annular section 18 of the control sleeve 14 has a radially outwardly projecting annular flange 18a, which is preferably configured with finger grooves for facilitating the grip of the annular flange 18a and thus the actuation of the control sleeve 14. To facilitate the firm grip of the base body 12, said base body is preferably designed to have gripping knobs 52.

In addition, it should be noted that the base body 12 is provided at its lower end in the Figures with a connecting piece 54 which is designed for connecting with a pipe section or a superordinate assembly. In the embodiment shown the connecting piece 54 is provided with a screw thread 54a for this purpose.

Lastly, it should also be added that the base body at the lower end of the mount 16 in FIG. 1 is delimited by a radially extending annular face 56, from the radially inner circumference of which an axial flange 58 projects into the mount 16. Radially outside said axial flange 58 an annular chamber 60 is formed which tapers in the direction of the annular flange 56 and, in cooperation with the end 32a of the pipe 32 inserted into the mount 16, ensures the sealing of the pipe 32 in the housing 12 without a separate sealing element being required.

FIGS. 5 to 7 show a second embodiment of a connector unit according to the invention which corresponds substantially to the embodiment according to FIGS. 1 to 4. Therefore, in FIGS. 5 to 7 analogous parts are denoted by the same reference numerals as in FIGS. 1 to 4, but increased by 100. Furthermore, the embodiment according to FIGS. 5 to 7 is only described in the following in the way that it differs from the embodiment according to FIGS. 1 to 4, and reference is otherwise made to the description thereof in particular.

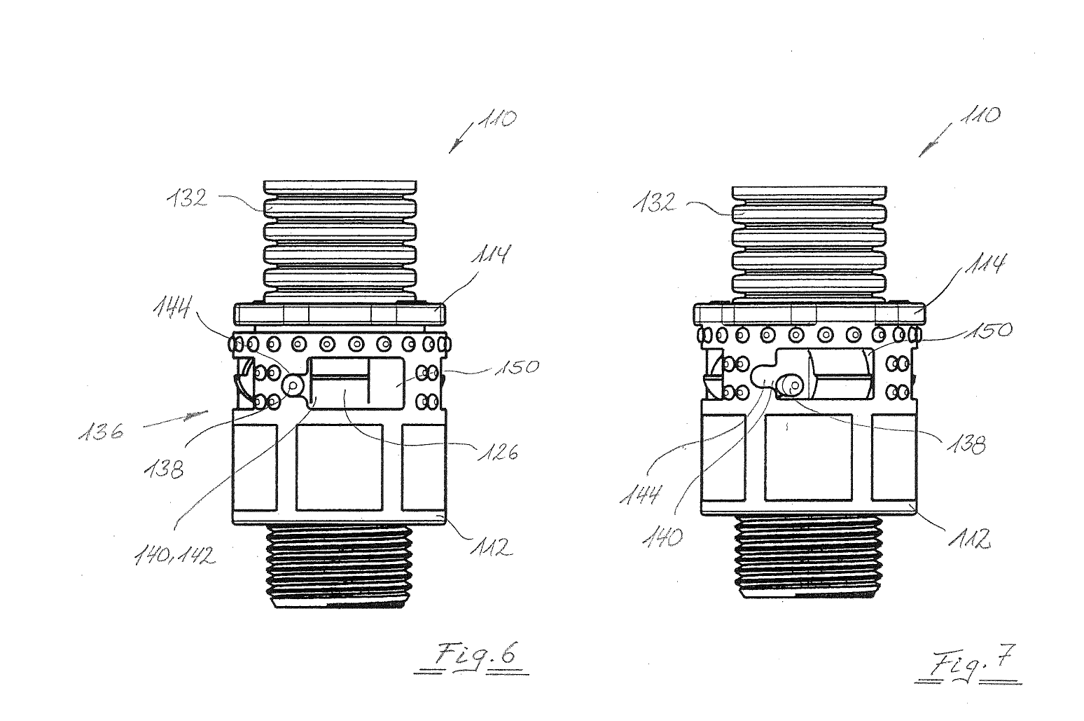

The connector unit 110 according to FIGS. 5 to 7 differs from the connector unit 10 according to FIGS. 1 to 4 in that the additional securing device 136 of the control sleeve 114 relative to the base body 112 is arranged adjacent to the window 150 mounting the holding element 126 not in axial direction but in circumferential direction (see FIGS. 6 and 7). Accordingly, the shoulder 138 is arranged in circumferential alignment with the holding element 126. Furthermore, the axial branch 142 of the substantially L-shaped window 140 is formed by the left end of the window 150 in FIG. 6. This means that the shoulder 138 in the second axial position of the control sleeve 114, which is shown in FIG. 7, is located in the left lower corner of the window 150. As also shown in FIG. 7, the circumferential branch 144 of the substantially L-shaped window 140 emerges from the left edge of the window 150. In the secured position of the control sleeve 114 relative to the base body 112 locked to the pipe 132 the shoulder 138 is arranged on the free end of said circumferential web 144 (see FIG. 6).

The connector unit 110 according to FIGS. 5 to 7 also differs from the connector unit 10 according to FIGS. 1 to 4 in that to seal the pipe 132 in the mount 116 of the base body 112, a separate sealing element is provided which is substantially cylindrical, tapers towards the annular shoulder 156 and rests on an annular shoulder 162a on the annular shoulder 156 of the base body 112. To improve the sealing engagement with the pipe 132 the sealing element 162 also comprises a plurality of radially inwardly projecting annular ribs 162b. It should be noted in this respect that in FIG. 5 the corrugated pipe 132 is not shown pulled through to the annular flange 162a of the sealing element 162, so that it does not block the view of the annular ribs 162b. The beginning of the further passage of the pipe 132 into the sealing element 162, i.e. away from the insertion opening 116a of the mount 116, is indicated by dotted lines in FIG. 5.

FIGS. 8 to 10 show a third embodiment of a connector unit according to the invention which corresponds essentially to the embodiments according to FIGS. 1 to 4 or according to FIGS. 5 to 7. Therefore, in FIGS. 8 to 10 analogous parts are denoted by the same reference numerals as in FIGS. 1 to 4, but increased by 200. The connector unit 210 according to FIGS. 8 to 10 is described in the following only in the extent to which it differs from the embodiment according to FIGS. 1 to 4 or according to FIGS. 5 to 7, and reference is otherwise made to the description thereof in particular.

The connector unit 210 according to FIGS. 8 to 10 differs from the embodiment according to FIGS. 1 to 4 in that the holding elements 264 are not integral with the control sleeve 214 but with the base body 212. In fact they are in the form of tongues which protrude increasingly from the inner circumferential wall 216b of the mount 216 in the insertion direction of the pipe 232 into the insertion opening 216a of the mount 216, as indicated in FIG. 8 by the arrow E, and thus extend in a radial direction to the outer circumferential surface of the pipe 232. At the free ends of said tongues 264 engagement elements 266 are formed which are intended for engaging with a circumferential recess 230 of the pipe 232.

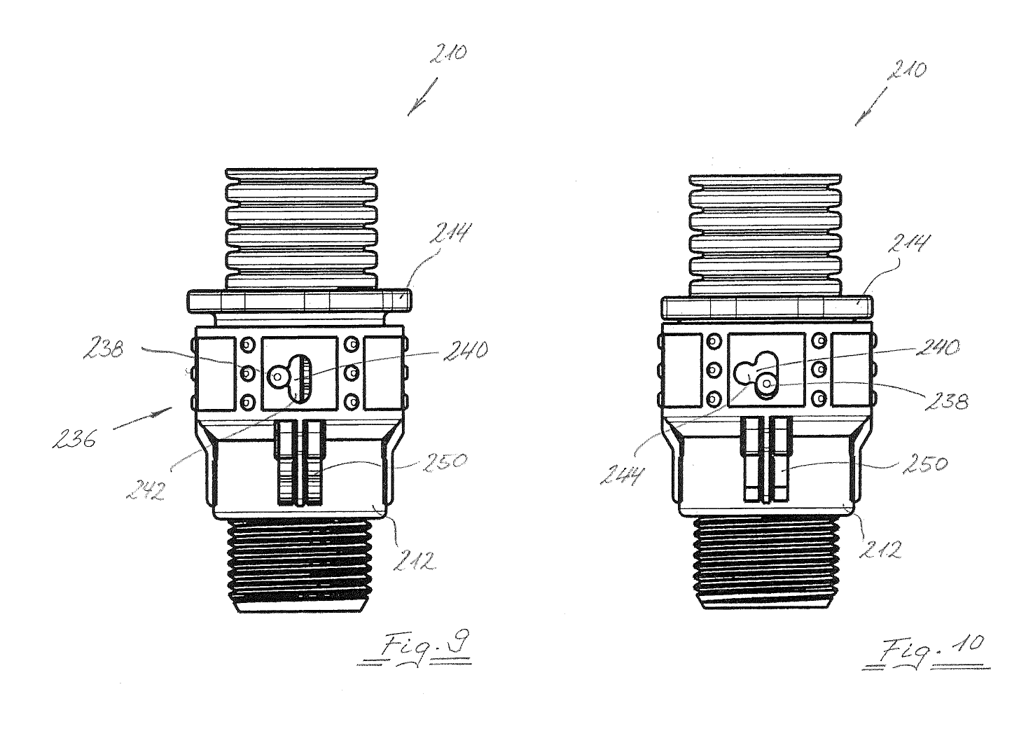

In the locked and secured position of the control sleeve 214 relative to the base body 212 shown in FIGS. 8 and 9 the control sleeve 214 is not in engagement with the holding elements 264, and so said holding elements are in holding engagement with the pipe 232. In the released position shown in FIG. 10 the holding elements 264 are pushed radially outwards from the bottom end of the control sleeve 214 in FIG. 8 against the inherent elasticity of the holding elements 264, so that the locking projections 266 are lifted out of the circumferential recess 230 and the pipe 232 can be pulled out of the connector unit 210 or its base body 212. The position of the holding elements 264 can be seen from the outside through the window 250 and thus monitored.

In the embodiment according to FIGS. 8 to 10 the substantially L-shaped window 240, used for mounting the shoulder 238, of the securing device 236 is provided with its axial branch 242 and its circumferential branch 244 independently of the window 250.

For all of the embodiments it should also be added that although the circumferential branch 44 or 144 or 244 extends to the left in all of the embodiments in the chosen view of the connecting point of the two branches 42 or 142 or 242 and 44 or 144 or 244 it could also equally extend to the right.

1. Connector unit, comprising
a base body with a mount delimited by an insertion opening for a pipe that does not form part of the connector unit or a hose that does not form part of the connector unit,
at least one holding element which is designed and intended to enter into holding engagement with a circumferential recess of the pipe or the hose, and
a control sleeve guided on the base body displaceably relative thereto,
the control sleeve being displaceable in the direction of a longitudinal axis of the base body relative thereto between a first axial position and a second axial position,
the at least one holding element in the
first axial position of the control sleeve being in holding engagement with the circumferential recess of the pipe or the hose, whilst said holding engagement can be released in the second axial position of the control sleeve,
wherein the control sleeve in the first axial position can be displaced in circumferential direction about the longitudinal axis of the base body between a first rotational position and a second rotational position, the control sleeve in its first rotational position can be moved into the second axial position, whereas in the second rotational position it is held by the base body in an interlocking manner in the first axial position.

2. Connector unit according to claim 1,
wherein control sleeve in the second rotational position is locked in place on the base body.

3. Connector unit according to claim 1,
wherein the control sleeve comprises at least one control piece which is mounted in a substantially L-shaped displacement track of the base body, the L-shape comprising one branch running substantially in the direction of the longitudinal axis and one branch running substantially in circumferential direction.

4. Connector unit according to claim 1,
wherein the branch of the L-shape running in the direction of the longitudinal axis opens into a window of the base body, in which the at least one holding element is mounted.

5. Connector unit according to claim 1,
wherein the branch of the L-shape running in the direction of the longitudinal axis is formed by a window of the base body, in which the at least one holding element is mounted.

6. Connector unit according to claim 1,
wherein the at least one holding element is integral with the base body.

7. Connector unit according to claim 6,
wherein the at least one holding element is formed by a tongue which protrudes from an outer delimiting wall of the base body in a direction pointing radially inwards and away from the insertion opening.

8. Connector unit according to claim 1,
wherein the at least one holding element is integral with the control sleeve.

9. Connector unit according to claim 1,
wherein the mount of the base body at its end farthest from the insertion opening for the pipe or the hose comprises an annular shoulder.

10. Connector unit according to claim 9,
wherein in the mount a sealing element is arranged which is supported on the annular shoulder.

11. Connector unit according to claim 9,
wherein on the radially inner edge of the annular shoulder a cylindrical flange is provided pointing towards the insertion opening, which together with the outer delimiting wall of the base body and the annular shoulder forms a sealing chamber for the pipe or the hose that tapers preferably towards the annular shoulder.

12. Connector unit according to claim 1,
wherein the control sleeve is also arranged in the mount.

13. Connector unit according to claim 1,
wherein one of the axial ends of the control sleeve protrudes out of the mount.
